(19) United States
(12) Patent Application Publication
(10) Pub. No.: US 2026/0036528 A1
(43) Pub. Date: Feb. 5, 2026

(54) MULTI-SPECTRAL IMAGING SYSTEM AND METHOD FOR CONDUITS

(71) Applicant: E.V. Offshore Limited, Norwich (GB)

(72) Inventors: Jonathan RUDD, Norwich (GB); Jonathan THURSBY, Norwich (GB); Matthew GIBSON-FORD, Norwich (GB); Fraser LOUDEN, Norwich (GB); Tobben TYMONS, Norwich (GB)

(21) Appl. No.: 19/103,451

(22) PCT Filed: Aug. 11, 2023
(86) PCT No.: PCT/GB2023/052129

§ 371 Date: Feb. 12, 2025

(30) Foreign Application Priority Data
Aug. 12, 2022 (GB) 2211802.0

(51) Int. Cl. G01N 21/954; G01M 3/38; G01N 21/88

(52) U.S. Cl. CPC G01N 21/954; G01M 3/38; G01N 21/8806; G01N 2021/8845; G01N 2021/9544

(57) ABSTRACT

A method of imaging an internal surface of a conduit, the method including deploying an inspection assembly within an internal volume of a conduit, the inspection assembly having a camera and a lighting array including a plurality of light emitters; illuminating a region of interest on said internal surface using the lighting array; and capturing image data of the region of interest using the camera, the image data including spatial data and intensity data at a plurality of different narrowband wavelength ranges of light.

### FIELD OF THE INVENTION

This invention relates to a camera system for imaging an internal surface of a conduit such as a pipe or wellbore. In particular, this invention relates to a multi-spectral or hyperspectral camera system for detection of abnormalities or defects in a conduit, such as corrosion, scale or leaks. This invention further relates to method of imaging an internal surface of a conduit, such as a pipe or wellbore. In particular, this invention also relates to a method of processing images captured within a conduit to create a map of abnormalities or defects. The invention further relates to the detection of different corrosion types and subsequent quantification of detected corrosion types in a conduit, and to the detection of different types of scale and properties of the scale.

### BACKGROUND TO THE INVENTION

Downhole tools exist that provide a camera to capture images within the visible spectrum of an internal surface of conduit, such as a pipe or downhole wellbore. These tools may be configured to provide images of abnormalities or defects such as cracks or corrosion within or on the internal surface of the conduit. These images may be viewed in real time by an operator of the tool, or may be stored for subsequent evaluation and analysis. One disadvantage of these camera systems is that the image captured by the camera within the visible spectrum cannot readily provide any quantification. For example, the extent or severity of corrosion may not be accurately determined, or the images may not provide suitable differentiation between different corrosion types. This is important as the extent and severity of an abnormality or defect, for example the extent and type of corrosion, may affect the remedial or monitoring work that results from the data analysis.

Furthermore, current methods for inspecting conduits, in particular pipelines or downhole wellbores that are in active use, require that the downhole tools have access to the pipe for inspection which results in significant intervention time and cost. In the case of a gas pipeline, current methods of inspection comprise the use of ultrasonics in combination with ultramagnetic or multi-finger measurements. These techniques require the gas in the pipeline to be replaced with a suitable liquid medium. Following inspection, the pipeline must then be completely drained and thoroughly dried prior to returning the pipeline to gas conveyance. These inspection methods therefore have a number of disadvantages, including the high intervention time that is required, during which the pipeline is unable to transport it's intended gas product, which results in a substantial cost due to the interruption to the gas supply during inspection and remedial work.

Taking corrosion as a particular example of an abnormality or defect within a conduit, as mentioned above, it is difficult for current imaging methods to determine between different types of corrosion. Remedial or repair work that must be carried out may be dependent on the type of corrosion. Furthermore, the rate at which an area of corrosion may increase or deteriorate may also be dependent on the type of corrosion mechanism. This then may determine how quickly further intervention is needed.

A number of common corrosion mechanisms in pipelines and downhole wellbores, such as those used to convey hydrocarbon products such as oil and gas, are known.

A first corrosion mechanism is Sulfide Stress Cracking (SSC) which is a form of hydrogen embrittlement or hydrogen induced cracking. This form of corrosion is commonly driven by the presence of hydrogen sulphide gas (H₂S) and water. This corrosion mechanism may be exacerbated by an increased partial pressure of the gas.

A second corrosion mechanism is the formation of an iron-sulphide scale. This may be referred to as general sulphur corrosion. The steady removal of iron from the steel material of the pipeline caused by the presence of H₂S results in the formation of ferrous sulphide, for example Iron(II) sulphide (FeS) or Iron(II, III) sulfide (Fe₃S₄), as the most common corrosion product. Depending on external conditions and the reactant environment, iron sulphides exist in several distinct crystalline forms with different ratios of iron to sulphur and, consequently, different physical and chemical properties. These different forms include troilite (FeS), marcasite (FeS₂), pyrite (FeS₂) and pyrrhotite (Fe₇S₈). Scale deposition depends on different factors such as temperature, pH, pressure, chemical reactions and equilibria, contact time, evaporation, and ionic strength.

A third corrosion mechanism is Stress Corrosion Cracking induced by lowering of localized pH due to formation of carbonic acid (CO₂+H₂O).

A fourth corrosion mechanism is induced by carbonic acid. The steady removal of iron from the steel material of the pipeline results in a tetracarbonylferrate anion (FeCO₄) corrosion product.

A fifth corrosion mechanism is Hydrochloric Acid (HCl) Corrosion. Hydrochloric acid is commonly used in gas well stimulation and can occur in the presence of chloride ions and water.

A sixth corrosion mechanism is oxidation caused by dissolved oxygen in water or from exposure to the atmosphere, resulting in the formation of Iron Oxide (FeO), Iron Peroxide (FeO₂) or Mixed Oxides (FeₙOₘ) compounds.

A seventh corrosion mechanism may be caused by the present of carbonic acid. Carbonic acid is a weak acid that is created when carbon dioxide (CO₂) is dissolved in water (H₂O), resulting in the formation of carbonic acid (H₂CO₃). This is particularly an issue for CO₂ sequestration pipelines and storage.

It will be understood that an area of corrosion within a conduit may be caused or exacerbated by the presence of a leak which may permit unwanted compounds to enter the internal volume of the conduit or may result in an increased or reduced concentration of particular compounds, resulting in one of the corrosion mechanisms described above.

In some pipelines or conduits the build-up of scale can also cause problems. The type of scale may vary depending on the minerals or materials present in the conduit. Some examples of scale calcium carbonate (CaCO₃), iron sulphide (FeS) and barium sulphate (BaSO₄).

It is an aim of the present invention to provide an alternative system and method for the inspection of conduits such as pipelines and wellbores that overcomes at least one problem associated with prior art inspection systems and methods, whether referred to herein or otherwise.

### SUMMARY OF THE INVENTION

A first aspect of the invention provides a method of imaging an internal surface of a conduit, the method comprising:
deploying an inspection assembly within an internal volume of a conduit, the inspection assembly comprising a camera and a lighting array including a plurality of light emitters;
illuminating a region of interest on said internal surface using the lighting array; and
capturing image data of the region of interest using the camera, the image data comprising spatial data and intensity data at a plurality of different, discrete narrowband wavelength ranges of light.

Preferably the lighting array comprises a plurality of subarrays and each subarray emits light at a different predetermined narrowband wavelength range. The lighting array may emit light in at least three different discrete narrowband wavelength ranges.

In other embodiments the light emitters emit wideband light and the method comprises filtering the light into a plurality of discrete narrowband wavelength ranges prior to image capture. In some embodiments the emitted light is filtered before illuminating the internal surface. In other embodiments the emitted light is filtered after illuminating the internal surface and before entering a lens of the camera.

In preferred embodiments the method comprises controlling the intensity of the light emitters to synchronize light emission at each of the different narrowband wavelength ranges of light in succession with image capture.

The image data may be captured at a constant frame rate.

The method preferably further comprises storing in memory or transmitting to a remote location image data captured at a plurality of locations along the conduit.

In preferred embodiments the method further comprises comparing the intensity data for each of the plurality of discrete narrowband wavelength ranges of light in the image data with a known spectral response for a particular abnormality, defect or detectable fluid.

In some embodiments the method further comprises the step of calculating a ratio of intensities for the plurality of discrete narrowband wavelength ranges of light in the image data and comparing said calculated ratio with known ratios from a spectral response for a particular abnormality, defect or detectable fluid.

Preferably the method comprises capturing location data as the inspection assembly moves through the internal volume of the conduit. In some embodiments the method then further comprises:
comparing, for each captured image, the intensity data for each of the plurality of discrete narrowband wavelength ranges of light in the image data with a number of known spectral responses for a plurality of different corrosion types;
determining, for each captured image, if corrosion is present; and
constructing a corrosion map of the internal surface of the conduit by associating image data with location data.

A second aspect of the invention provides a conduit inspection assembly for capturing images of an interior surface of said conduit, the conduit inspection assembly comprising:
an elongate tubular housing;
a lighting array comprising a plurality of light emitters arranged to illuminate said interior surface; and
a camera having an image sensor configured to detect a plurality of different, discrete narrowband wavelength ranges of light.

In some embodiments the camera is a sideview camera and the lighting array comprises a plurality of annular subarrays extending circumferentially around the inspection assembly. In other embodiments the camera is a forward-facing or down view camera and the lighting array comprises a plurality of concentric annular subarrays disposed rearwardly of a lens of the camera, each of the light emitters being generally forward-facing.

In preferred embodiments the light emitters in each of the subarrays emit light in a different discrete narrowband wavelength range. In other embodiments the conduit inspection assembly may comprise an optical filtering module arranged to filter light into a plurality of discrete narrowband wavelength ranges prior to entering a lens of the camera.

To enable the inspection assembly to operate in harsh conditions such as in hydrocarbon pipelines and wellbores, the conduit inspection assembly preferably comprises a sapphire window element covering each of the camera and lighting array.

In preferred embodiments the light emitters comprise light emitting diodes, each light emitting diode emitting light in a narrowband wavelength range.

In preferred embodiments the camera is a hyperspectral camera.

In preferred embodiments each of the plurality of discrete narrowband wavelength ranges has a full width half maximum value of no more than 30 nm.

In preferred embodiments the plurality of discrete narrowband wavelength ranges comprises two or more within a set of wavelength ranges comprising 500-520 nm, 660-680 nm, 760-770 nm, 830-850 nm and 900-1700 nm.

The conduit may be a pipeline, casing, liner, tubing or wellbore.

A third aspect of the invention discloses use of the conduit inspection assembly of the second aspect of the invention to image an internal surface of a pipeline conveying a fluid to determine the presence of an anomaly or defect. The fluid may be a liquid or a gas. The anomaly or defect may include an area of corrosion. The images may be used to characterize, measure, quantify or resolve the anomaly or defect.

Preferred and/or optional features of each aspect and embodiment described above may also be used, alone or in appropriate combination, in the other aspects and embodiments also.

### BRIEF DESCRIPTION OF THE DRAWINGS

The invention will now be further described by way of example only and with reference to the accompanying drawings, in which like reference signs are used for like features, and in which:

FIG. 1 is a perspective view of a multi-sideview camera system in accordance with a first preferred embodiment of the present invention;

FIG. 2 is a cross-sectional view of the camera of FIG. 1 along the line II-II;

FIG. 3 is a perspective sectional view of the camera of FIG. 1 also along the line II-II;

FIG. 4 is a perspective view of a forward-facing or down view camera system in accordance with a second embodiment of the present invention;

FIG. 5 is an end view of the forward-facing or down view camera system of FIG. 4;

FIG. 6 is a cross-sectional view of the forward-facing or down view camera of FIG. 4 along the line VI-VI Of FIG. 5; and

FIG. 7 is a perspective sectional view of the forward-facing or down view camera of FIG. 4 also along the line VI-VI.

### DETAILED DESCRIPTION

A camera system according to the present invention is configured to be deployed within an internal volume of a conduit. The camera system may be deployed within a pipeline that is above ground or below ground level and which may be disposed generally horizontally or generally vertically. The camera system may be deployed within an internal volume of a wellbore or in another downhole environment. In many cases the camera systems of the present invention will be used to inspect the internal surfaces of conduits that convey hydrocarbon fluids, such as oil and gas, or similar.

It is envisaged that the camera system will be used to visualize abnormalities and defects within the conduit, in particular on internal surfaces of the conduit. The camera system may be used to detect, for example areas of corrosion or leaks within the conduit. The camera system may be used to detect the presence of scale on surfaces within the conduit. The camera system may be used to monitor fluid flow through the conduit. Images captured by the camera system may be used to quantify a specified conduit condition or parameter, for example type or extent of corrosion or scale, or fluid movement.

The camera systems of the present invention generally provide a plurality of light sources arranged to illuminate an area of interest on an internal surface of a conduit. One or more cameras disposed in proximity to the light sources are arranged to capture images of the illuminated area. The camera systems are configured to capture images at two or more discrete wavelengths of light. This may be achieved in some embodiments by illuminating the area of interest with light sources that emit light at two or more specific wavelengths and in other embodiments by using broadband light sources and subsequently filtering the light prior to image capture.

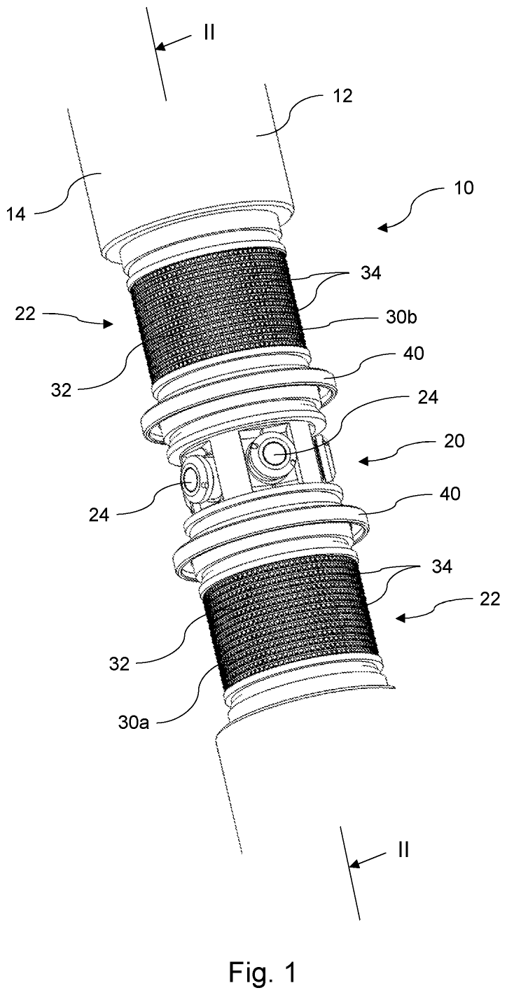

A first embodiment of an inspection assembly or camera system 10 according to the invention is shown in FIGS. 1 to 3. It will be appreciated that the camera system 10 may form part of a larger inspection tool or downhole tool 12, and accordingly, FIGS. 1 to 3 show in detail only the parts of the system relating to image capture as described further below.

The inspection tool 12 comprises an elongate housing 14 having a longitudinal axis 16. The housing 14 is generally cylindrical and includes a substantially annular side wall 18. The housing side wall 18 has an outer surface that defines an outer or external diameter of the inspection tool 12. It will be understood that a maximum radial dimension of the inspection tool 12 is generally dependent on an internal diameter of the conduit to be inspected.

The inspection assembly 10 will typically be used to image an internal surface of a pipe or conduit within which the inspection assembly 10 is located. In particular, the inspection assembly 10 of the present invention may be used to image an internal surface of a wellbore, casing or pipeline. The wellbore, casing or pipeline may have an internal diameter of between 50 mm and 255 mm. Furthermore, the inspection assembly 10 may be required to operate in temperatures up to 150° C. and at pressures of up to 20 kpsi (138 MPa).

When the inspection assembly 10 is used to image a wellbore or casing, the inspection assembly 10 may be deployed on slickline cable or e-line cable. If the inspection assembly is deployed on slickline cable, images captured by the one or more cameras are stored in a memory of the inspection assembly. If the inspection assembly 10 is deployed on e-line cable, images captured by the one or more cameras may be stored in a memory of the inspection assembly and/or transmitted in real-time to a receiver which will typically be located at ground level. Deploying the inspection assembly 10 on e-line cable therefore allows live images to be transmitted to a controller at a location remote from the inspection assembly and/or wellbore.

In this embodiment the inspection assembly 10 comprises a camera section 20 and two lighting sections 22 including light sources arranged to emit light to illuminate the field of view of the camera(s). The camera section 20 preferably includes two or more cameras 24 arranged to capture an image of an internal surface of the wellbore or conduit surrounding the inspection assembly 10. In this embodiment the camera section 20 includes five cameras 24 spaced equidistantly around a circumference of the housing 14. The cameras 24 are side view cameras 24 and are configured such that an optical axis of the field of view of each of the cameras 24 extends substantially radially from the inspection assembly 10. The number of cameras 24 and the angle of view or field of view of each of the cameras 24 is preferably selected such that the combined images captured by the cameras 24 cover a complete 360° circumferential view of the internal surface of the wellbore or conduit. Accordingly, in this embodiment, the arrangement of five cameras 24 requires a 72° spacing between each neighbouring cameras 24 to provide the 360° image acquisition of the observed inner wall.

The cameras 24 of the inspection assembly 10 may capture still images and/or video images. Images may be captured at a constant frame rate, for example 24 frames per second (fps), 30 fps or 60 fps.

Each camera 24 comprises an image sensor 26 and at least one lens 28. The image sensor 26 may be a CMOS image sensor. In use, light from the field of view passes through the lens 28 and impinges the image sensor 26. It will be appreciated that the image sensor may be optically aligned with the lens or, alternatively, a prism or mirror may be positioned between the lens and the image sensor such that the optical path between the lens and the image sensor is bent through an angle of, for example, about 90°.

Each of the two lighting sections 22 includes a lighting array 30, and the lighting arrays are located adjacent the side view cameras 24 to illuminate the field of view. The lighting arrays 30 are spaced apart in a direction along the longitudinal axis 14 of the inspection assembly 10. In this embodiment a first array 30a, in a first lighting section 22, is located on a first side of the cameras 24 and a second array 30b, in a second lighting section 22, is located on a second side of the cameras 24.

Each lighting array 30 comprises a plurality of light sources or light emitters 32 disposed around a circumference of the housing 14. Each light emitter 32 is positioned such that a centre line or optical axis of the emitted light extends radially from the housing 14. The light emitters 32 are preferably arranged around the housing 14 so as to evenly illuminate an annular area around the inspection assembly 10. In preferred embodiments the light emitters 32 are light emitting diodes (LEDs). The light emitters may comprise nano-LEDs.

Within each lighting array 30, in this embodiment, the light emitters 32 are arranged in a plurality of annular subarrays or rings 34 which extend circumferentially about the lighting section 22. In this embodiment each annular subarray 34 comprises an equal number of light emitters 32. Furthermore, each light emitter 32 of a first one of the annular subarrays 34 is disposed adjacent a corresponding light emitter 32 of a second, neighbouring annular subarray 34. In this way, the light emitters 32 of each lighting array 30 are also arranged in lines or rows that extend parallel to the longitudinal axis 16 of the inspection tool 12.

In this embodiment each lighting array 30 comprises fifteen annular subarray rings 34. In other embodiments the number of annular subarrays 34 within each lighting array 30 may be more or less than fifteen, and the number of annular subarrays 34 may be dependent upon the desired application of the inspection assembly 10. Each lighting array 30 may comprise between two and thirty annular subarrays 34, preferably each lighting array 30 may comprise between five and twenty five annular subarrays 34, most preferably each lighting array 30 may comprise between ten and twenty annular subarrays 34.

In preferred embodiments each annular subarray 34 comprises light emitters 32 (most preferably LEDs) that emit light at a predetermined wavelength. It will be appreciated that each light emitter 32 will emit light over a range of wavelengths, but that this wavelength range is preferably narrow, and is centred at the predetermined wavelength required for image capture. Accordingly, in the following description it will be appreciated that references to predetermined wavelengths encompass predetermined narrowband wavelength ranges. Preferably, each annular subarray 34 comprises light emitters 32 emitting light at a different predetermined wavelength to the light emitters 32 of the other annular subarrays 34. Therefore, in this embodiment, each lighting array 30 is able to emit light at fifteen different and distinct predetermined wavelengths.

Alternatively, each annular subarray 34 may comprise light emitters 32 that emit light at two or more different and distinct predetermined wavelengths. For example, neighbouring light emitters 32 around the annular subarray 34 may emit light at two alternating predetermined wavelengths. In other embodiments a first section of light emitters 32 may emit light at a first predetermined wavelength and a second section of light emitters 32 may emit light at a second predetermined wavelength. The light emitters 32 which emit the first predetermined wavelength may be located about a 0° to 179° portion of the annular subarray 34 and the light emitters 32 which emit the second predetermined wavelength may be located about a 180° to 359° portion of the annular subarray 34. In yet further embodiments each annular subarray 34 may emit light of three or more wavelengths, with either a repeating pattern of light emission extending around the annular subarray 34 or with angular sections of the annular subarray 34 emitting light at different wavelengths.

In other embodiments more than one annular subarray 34 in each lighting array 30 may emit light at a particular predetermined wavelength, thereby providing a substantially increased intensity of emitted light at each wavelength. This may be useful for illuminating conduits having a larger internal diameter.

Each of the predetermined wavelengths may be associated with the detection of a different abnormality or defect that may be present within the conduit, for example each wavelength may be associated with a different type of corrosion or scale. Alternatively, a plurality of wavelengths may provide a “fingerprint” or defined spectral response by which a particular corrosion type, type of scale, or defect type may be identified.

In use all of the light emitters 32 may be configured to emit light at the same time. However, in preferred embodiments the output intensity of each light emitter is controllable from a “high” intensity state to a “no” intensity state (i.e. an off state). This allows the lighting arrays 30 to be controlled to illuminate the area of interest with only a single wavelength of light at a given time.

As described above, in preferred embodiments, the inspection assembly 10 comprises a camera section 20 and two lighting sections 22, each lighting section 22 being on an opposite side of the camera section 20. To provide an even illumination at each of the desired predetermined wavelengths of light, it is preferable if, for each predetermined wavelength, the distance between the cameras 24 and the light emitters 32 emitting that wavelength of light in the first annular subarray 34 is the same as the distance between the cameras 24 and the light emitters 32 emitting that wavelength of light in the second annular subarray 34.

For example, within each lighting array 30, a first or inner-most annular subarray 34, nearest to the camera section 20, may comprise LEDs which emit light at a first predetermined wavelength. A second, neighbouring annular subarray 34 in each array 15, may comprise LEDs which emit light at a second predetermined wavelength This pairing of the annular subarrays 34 may be repeated throughout the lighting arrays 30, thus providing an even distribution of light about the camera section 20.

Each lighting section 22 comprises a window element or cover 36 made of a suitable light transmitting material that surrounds the light emitters 32 and protects them from the environment within the conduit in which the inspection assembly 10 is deployed. The camera section 20 comprises a similar window element or cover 38 that surrounds and protects the cameras 24. In particular, the window elements 36, 38 may protect both the lighting elements 32 and the cameras 24 from fluids being conveyed through the conduit within which the inspection assembly 10 is deployed.

In use, the light emitted by the light emitters 32 passes through the window element 36 of the lighting section 22 before illuminating the fields of view of the cameras. The light then passes through the window element 38 of the camera section 20 before entering the camera lens. In preferred inspection assemblies 10, a single window element 36 extends around the full circumference of the housing 14 and covers all of the light emitters in each one of the lighting arrays 30. Similarly, a single window element 38 extends around the full circumference of the housing 14 and covers all of the cameras 24 in the camera section 20. This reduces the number of components and the number of seals that must be formed between the window elements 36, 38 and the housing 14.

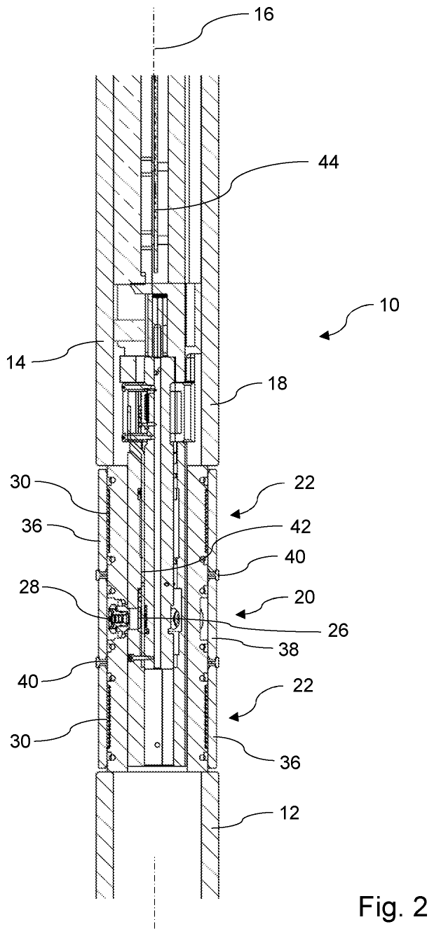

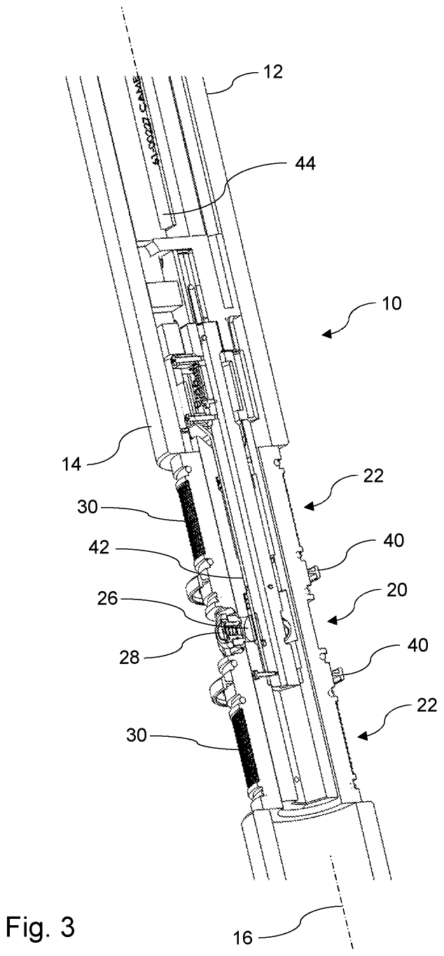

In this embodiment, arranged between the camera section 20 and each of the lighting sections 22, there is an annular collar 40 which comprises a flanged outer surface. The annular collars 40 retain three cylindrical window elements or covers 36, 38. This is shown in FIG. 2 (the window elements have been omitted from FIGS. 1 and 3 for clarity).

In order to withstand, in particular, the high pressures within a wellbore the window elements 36, 38 are preferably made from sapphire. Each sapphire window element 36, 38 preferably has a thickness of at least 4 mm. Sapphire has a high tensile strength, as well as being resistant to impacts and scratching.

As shown in FIGS. 2 and 3, each image sensor 26 is arranged on an image sensor circuit board 42. The circuit board 42 may be electrically connected to suitable video processing units 44 within the inspection tool 12, as illustrated in this embodiment. In other embodiments the images captured by the image sensors 26 may be stored in a memory, or may be transmitted to a remote location by suitable transmitting equipment in the inspection tool 12.

In use, the inspection assembly 10 is deployed in a conduit to capture images of the internal surface of the conduit. The light emitters 32 emit light at predetermined wavelengths to illuminate the internal surface. Due to the lack of ambient light within the conduit, the inspection assembly 10 can accurately control the illumination of the internal surface of the conduit.

As the inspection assembly 10 travels or moves through the conduit, the cameras 24 preferably capture images at multiple frames per second. Each frame captures an image at one wavelength of light dependent on the wavelength of light emitted by the lighting arrays 30. Accordingly, a control unit preferably controls the intensity of light emitted from each of the subarrays 34 in the lighting arrays 30 so that light of each different wavelength is emitted as successive frames or images are captured by the cameras 24. In this way the power control to the light emitters 32 is synchronized with the frame rate of the cameras 24. In other words, the wavelength of light emitted by the lighting arrays 30 cycles through the different predetermined wavelengths of the light emitters 32. Each image or frame therefore comprises spatial data and intensity data at a single predetermined wavelength. Preferably the speed of travel or movement of the inspection assembly 10 through the conduit and the frame rate of the cameras 24 are chosen so that for a system capturing images at n different wavelengths there is overlap between the first image and the (nth+1) image such that images captured at the same wavelength of light can subsequently be mosaiced or “stitched” together to form a complete image of the internal surface of the conduit.

It will be appreciated that video data or image data captured by the cameras 24 may be stored in memory on board the inspection tool 12 or may be transmitted directly and in real time to a remote location, such as to the surface above a downhole well bore. Furthermore, the video data or image data may be stored or transmitted in a number of different ways. In some embodiments a “data cube” may be formed comprising a set of images, each image of the set being captured at one of the predetermined wavelengths of light in successive frames or images. For example, if an inspection assembly 10 emits light at ten different wavelengths, a first data cube may contain frames one to ten of the video data and a second data cube may contain frames eleven to twenty, and so on. Alternatively, the image data may be formed into a series of “streams” with each stream consisting of images captured at a particular wavelength of light. Taking the above example of ten different wavelengths, a first stream would include frames one, eleven, etc., a second stream would include frames two, twelve, etc., and so on.

In the preceding description the cameras 24 have been described as capturing images at the wavelength of the emitted light. In some embodiments the cameras 24 are configured to capture light in the same narrowband wavelength range as the emitted light. In other embodiments the abnormality or defect to be detected, for example a specific type of corrosion or scale, may cause a known excitation of the light or shift in the wavelength of light, such that the light reflected by or emitted from the abnormality or defect is different to the original wavelength of light emitted by the light emitters 32.

The images captured by the cameras 24 may be subsequently processed to identify and highlight pixels and groups of pixels in the images that correspond to abnormalities or defects. For example, for a given set of images including a pixel at a corresponding position or location in the conduit, the intensity of one or more wavelengths of light in that pixel is measured. The measured intensities are analyzed to determine if they correspond to spectral responses or “fingerprints” from particular types of defects, for example particular types and magnitude of corrosion or scale.

In other embodiments the inspection assembly 10 may be used in conjunction with a detectable fluid, having a known spectral response or “fingerprint”, being introduced into the flow of fluid within the conduit. Images captured by the cameras 24 may then be used to track the flow of the detectable fluid through the conduit. This may be used to quantitatively analyze the flow or movement of fluid through the conduit, or may be used to detect the presence of a leak. The detectable fluid may be water, or a hydrocarbon liquid such as oil, for example.

In some embodiments the inspection tool 12 or inspection assembly 10 may include sensors to detect the distance or depth of the inspection tool 12 or inspection assembly 10 along the conduit. Areas affected by corrosion or scale, or areas in which a defect is identified from the image processing may then be catalogued or associated with depth or distance data to produce a map of detected corrosion types, scale types and/or defect types through the conduit.

The data may be reviewed by analysts in isolation or against previous data logs to determine changes in position and magnitude of corrosion, scale or defect. It is also possible to apply machine learning Al to the datasets to automatically detect and highlight corrosion/scale/defect locations, patterns, magnitudes, and sizes.

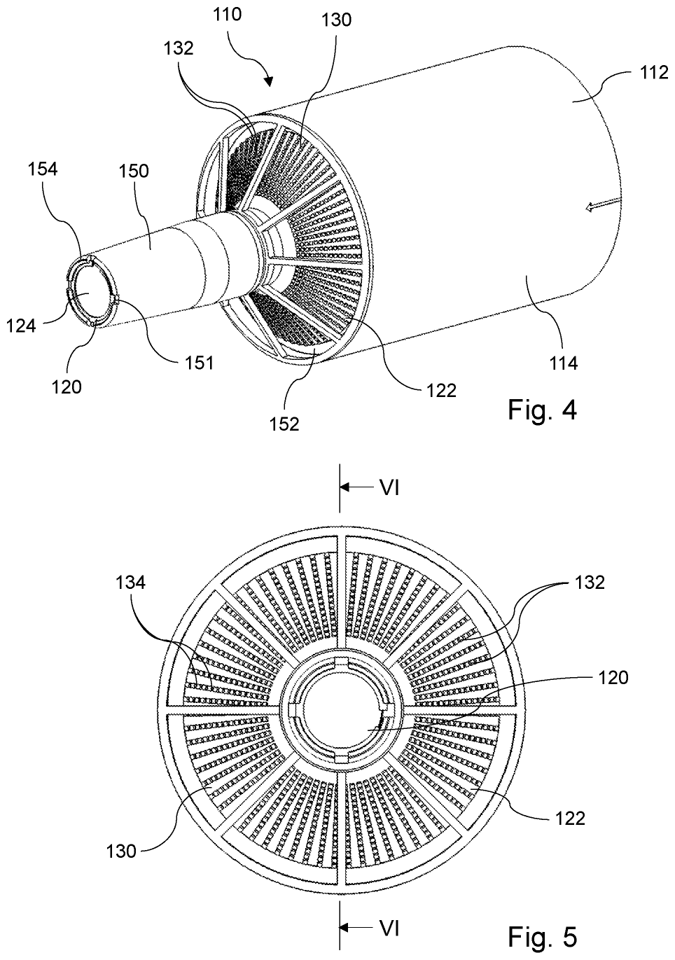

A second embodiment of an inspection assembly or camera system 110 according to the invention is shown in FIGS. 4 to 7. It will be appreciated that the camera system 110 may form part of a larger inspection tool or downhole tool 112, and accordingly, FIGS. 4 to 7 show in detail only the parts of the system relating to image capture as described further below.

In this embodiment the inspection assembly 110 comprises a camera section 120 and a lighting section 122 including a plurality of light sources 132. The camera system 110 is disposed at an end of the inspection tool 112 and the camera section 120 includes a single down view or forward-facing camera 124 arranged to capture an image of an internal surface of the wellbore or conduit ahead of the inspection assembly 110 (compared to the direction of movement of the inspection tool 112). The camera 124 is positioned centrally with respect to a housing 114 of the inspection tool 112 on a longitudinal axis 116 of the inspection tool 112.

The camera 124 comprises an image sensor 126 and at least one lens 128. The image sensor 126 may be a CMOS image sensor. In use, light from the field of view passes through the lens 128 and impinges the image sensor 126. The camera 124 of the inspection assembly 110 may capture still images and/or video images.

The lighting section 122 is disposed rearward of the camera lens 128. The lighting section comprises an annular lighting array 130. The lighting array 130 comprises a plurality of light sources or light emitters 132 disposed around the axis 116 of the tool 112. Each light emitter 132 is positioned such that a centre line or optical axis of the emitted light extends forwardly, generally in a longitudinal direction, from the housing 114. The light emitters 132 are preferably arranged to evenly illuminate an area of the internal surface of the conduit ahead of the camera 124. The light emitters 132 may be angled so that the centre line or optical axis of the emitted light from each of the light emitters 132 diverges from the longitudinal axis 116. In preferred embodiments the light emitters 132 are light emitting diodes (LEDs).

In this embodiment the inspection assembly 110 comprises a central cylindrical section 150 which protrudes perpendicularly from an end face 152 of the housing 114, at a forward end of the housing 114. The cylindrical section 150 is generally frustro-conically shaped and comprises a free unattached end 154 which has a smaller diameter than its opposite end. The free end 154 of the cylindrical section 150 comprises an optical window element 138 which is arranged to provide an optical path along the longitudinal axis 116 and allow light to enter the camera 124.

The central cylindrical section 150 comprises castellation recesses 151 in the free end 154 which are equally spaced around the perimeter of the window element 138. In this embodiment there are four castellation recesses 151 spaced from each other by 90°. The castellation recesses allow any liquid or other material to drain or escape from the optical window element 138.

The annular lighting array 130 is provided on the annular end face 152 of the housing 116 surrounding the cylindrical section 150. In preferred embodiments the annular end face is a frusto-conical surface, with a central portion of the end face being forward of a perimeter portion of the end face. A plurality of window elements or covers 136 made of a suitable light transmitting material are disposed over the lighting array 130, thereby protecting the lighting array 130 from the environment within the conduit in which the inspection assembly 110 is deployed.

In order to withstand, in particular, the high pressures within a wellbore the window elements 136, 138 are preferably made from sapphire. Each sapphire window element 136, 138 preferably has a thickness of at least 4 mm. Sapphire has a high tensile strength, as well as being resistant to impacts and scratching.

Within the lighting array 130, in this embodiment, the light emitters 132 are arranged in a plurality of concentric annular subarrays 134. In this embodiment each annular subarray 134 comprises an equal number of light emitters 132. Furthermore, in each annular subarray 134 the light emitters 134 are equidistantly spaced. This results in the light emitters 134 also being disposed in a plurality of lines or rows that extend radially from the central cylindrical section 150 outwardly towards the outer surface of the housing 114. This arrangement of light emitters 132 provides a lighting array 130 which emits the required illumination evenly from the area of the end face 152.

In this embodiment the lighting array 130 comprises fifteen annular subarrays or rings 134. In other embodiments the number of annular subarrays 134 may be more or less than fifteen, and may be dependent upon the desired application of the inspection assembly 110. The lighting array 130 may comprise between two and thirty annular subarrays 134, preferably the lighting array 130 comprises between five and twenty five annular subarrays 134, most preferably the lighting array 130 comprises between ten and twenty annular subarrays 134.

In preferred embodiments each annular subarray 134 comprises light emitters 132 (most preferably LEDs) that emit light at a predetermined wavelength. It will be appreciated that each light emitter 132 will emit light over a range of wavelengths, but that this wavelength range is preferably narrow, and is centred at the predetermined wavelength required for image capture. Preferably, each annular subarray 134 comprises light emitters 132 emitting light at a different predetermined wavelength to the light emitters 132 of the other annular subarrays 134. Therefore, in this embodiment, the lighting array 130 is able to emit light at fifteen different and distinct predetermined wavelengths.

Alternatively, each annular subarray 134 may comprise light emitters 132 that emit light at two or more different and distinct predetermined wavelengths. For example, neighbouring light emitters 132 around the annular subarray 134 may emit light at two alternating predetermined wavelengths. In other embodiments a first section of light emitters 132 may emit light at a first predetermined wavelength and a second section of light emitters 132 may emit light at a second predetermined wavelength. The light emitters 132 which emit the first predetermined wavelength may be located about a 0° to 179° portion of the annular subarray 134 and the light emitters 132 which emit the second predetermined wavelength may be located about a 180° to 359° portion of the annular subarray 134. In yet further embodiments each annular subarray 134 may emit light of three or more wavelengths, with either a repeating pattern of light emission extending around the annular subarray 134 or with angular sections of the annular subarray 134 emitting light at different wavelengths.

In use, all of the light emitters 132 may be configured to emit light at the same time. In other embodiments the output intensity of each light emitter may be controllable from a “high” intensity state to a “no” intensity state (i.e. an off state). This may be used to illuminate the area of interest with only a single wavelength of light at a given time.

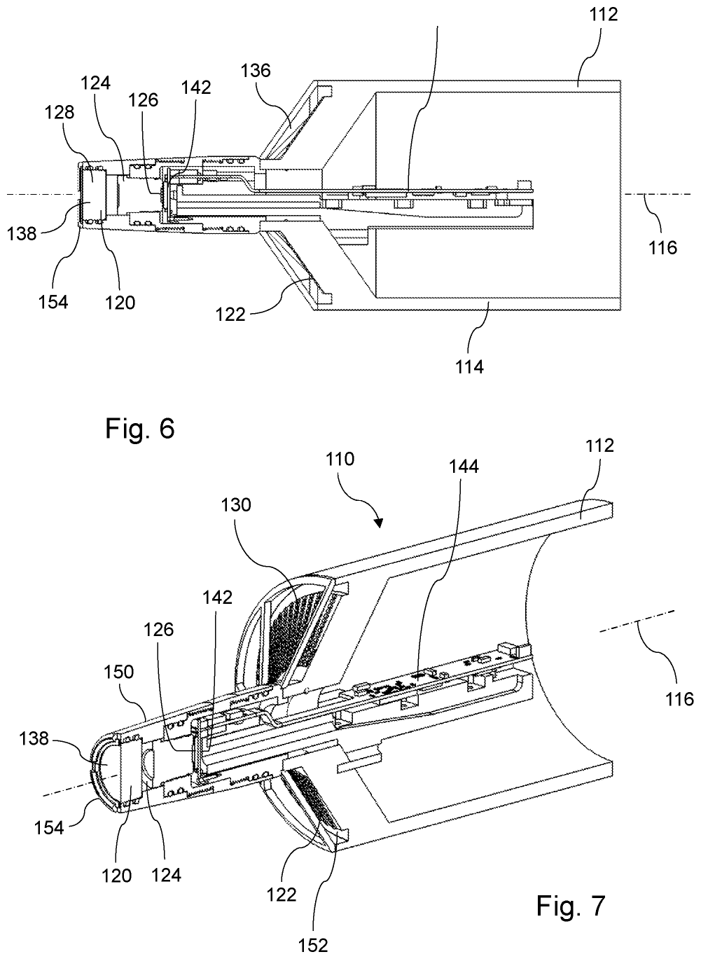

As shown in FIGS. 6 and 7, the image sensor 126 is arranged on an image sensor circuit board 142. The circuit board 142 may be electrically connected to a suitable video processing unit 144 within the inspection tool 112, as illustrated in this embodiment. In other embodiments the images captured by the image sensor 126 may be stored in a memory or may be transmitted to a remote location by suitable transmitting equipment in the inspection tool 112.

In both embodiments described above, the light emitters 32, 132 are configured to emit light at specific predetermined wavelengths. The image sensor or image sensors 26, 126 then capture images at these wavelengths or predetermined corresponding wavelengths, for example due to a known excitation response. These embodiments may therefore be considered to be multi-spectral camera systems. In other embodiments the light emitters may be broadband or wideband light emitters that emit light over a wide range of wavelengths. In these embodiments the inspection assembly preferably comprises wavelength band filtering optics to subsequently filter the wavelengths of light captured by the image sensor or image sensors. The wavelength band filtering optics may comprise one or more optical bandpass filters. The filtering optics may be controlled and synchronized to the image capture. The cameras used in these embodiments may be hyperspectral cameras. The hyperspectral cameras may capture a large number of narrow spectral bands of reflected light over a wide range of wavelengths. For example, the hyperspectral camera may capture 448 narrow spectral bands with wavelengths ranging from 397 nm to 1004 nm (i.e. visible and near infrared). The hyperspectral camera may be capable of nano-imaging.

An inspection assembly according to the invention may include a control system to control the intensity of light emitted from one or more of the lighting subarrays 34, 134. This may allow the intensity of the emitted light to be increased in larger diameter conduits. The control system may also be configured to increase the intensity of a first subarray emitting light of a first wavelength compared to the intensity of a second subarray emitting light of a second wavelength. In both cases this may help optimize the signal to noise ratio of the captured images.

In some embodiments the control system may be configured to synchronize illumination of the lighting array(s) to image capture. In particular, in embodiments in which the camera(s) are video camera(s), the control system may cause the light emitters to emit light in flashes or bursts having the same frequency as the frame rate of the video camera(s).

In preferred embodiments, and as described above, the inspection assembly is incorporated in an inspection tool or downhole tool that may be deployed on e-line, coiled tubing or the like. In other embodiments the inspection assembly may be installed permanently in a fixed location within a conduit to permit monitoring and early detection of corrosion or defects within the conduit or to permit monitoring of fluid flow within the conduit, for example. Systems of this type may be deployed in regions that have previously been identified as being at high risk of corrosion or as having an increased likelihood of a build-up of scale. By identifying issues at the earliest opportunity, the remedial work that is needed may be lessened, decreasing the intervention time and cost.

During processing and analysis of the captured data, the captured spectra may be compared to known spectral “fingerprints” of specific corrosion or scale types. These spectral “fingerprints” may be determined by previous experimentation under controlled conditions. For example, experiments have determined a number of wavelength bands that are important in detecting and identifying corrosion. In preferred embodiments the inspection assembly is configured to capture image data in one or more of the wavelength bands 500-520 nm, 660-680 nm, 760-770 nm, 830-850 nm and 900-1700 nm. As discussed above, in some embodiments the inspection assembly may comprise light emitters that emit light only at these predetermined wavelengths. In other embodiments the light emitters may be wideband light emitters employed together with a hyperspectral camera, with suitable optical bandpass filters that filter the captured light for these specific wavelengths.

Analysis of the captured data may look for ratios of reflectance values or normalized reflectance values at a number of different wavelengths to determine a “fingerprint” or spectral response for a particular abnormality or defect type, such as a particular corrosion or scale type or to determine a severity of a particular type of corrosion. Alternatively the captured data may be analyzed to look for variations of intensity at a predetermined wavelength to monitor, for example, patterns of fluid flow in a conduit.

The present invention therefore provides an inspection assembly for use in a conduit that captures image data at multiple predetermined wavelengths of light for detection of abnormalities, corrosion, scale or other defects, or for monitoring fluid flow. The system and method of the present invention may allow different types of corrosion to be detected and distinguished, may allow monitoring of an area to determine a change in severity of corrosion over time, and may allow quantification of fluid flow and/or the detection of leaks.

Other modifications and variations not explicitly disclosed above may also be contemplated without departing from the scope of the invention as defined in the appended claims.

1. A method of imaging an internal surface of a conduit, the method comprising:
deploying an inspection assembly within an internal volume of a conduit, the inspection assembly comprising a camera and a lighting array including a plurality of light emitters;
illuminating a region of interest on said internal surface using the lighting array; and
capturing image data of the region of interest using the camera, the image data comprising spatial data and intensity data at a plurality of different narrowband wavelength ranges of light.

2. A method as claimed in claim 1, in which the lighting array comprises a plurality of subarrays and each subarray emits light at a different predetermined narrowband wavelength range.

3. A method as claimed in claim 2, in which the lighting array emits light of at least three different discrete narrowband wavelength ranges.

4. A method as claimed in claim 1, in which the light emitters emit wideband light and the method comprises filtering the light into a plurality of discrete narrowband wavelength ranges prior to image capture.

5. A method as claimed in claim 4, in which the emitted light is filtered before illuminating the internal surface, or in which the emitted light is filtered after illuminating the internal surface and before entering a lens of the camera.

6. (canceled)

7. A method as claimed in claim 1, comprising controlling the intensity of the light emitters to synchronize light emission at each of the different narrowband wavelength ranges of light in succession with image capture.

8. (canceled)

9. A method as claimed in claim 1, further comprising storing in memory or transmitting to a remote location the image data captured at a plurality of locations along the conduit.

10. A method as claimed in claim 1, further comprising comparing the intensity data for each of the plurality of discrete narrowband wavelength ranges of light in the image data with a known spectral response for a particular abnormality, defect or detectable fluid.

11. A method as claimed in claim 1, further comprising the step of calculating a ratio of intensities for the plurality of discrete narrowband wavelength ranges of light in the image data and comparing said calculated ratio with known ratios from a spectral response for a particular abnormality, defect or detectable fluid.

12. A method as claimed in claim 1, comprising capturing location data as the inspection assembly moves through the internal volume of the conduit.

13. A method as claimed in claim 12, further comprising:
comparing, for each captured image, the intensity data for each of the plurality of discrete narrowband wavelength ranges of light in the image data with a number of known spectral responses for a plurality of different corrosion or scale types;
determining, for each captured image, if corrosion or scale is present; and
constructing a corrosion or scale map of the internal surface of the conduit by associating image data with location data.

14. A method as claimed in claim 13, further comprising the step of identifying, for each detected region of corrosion or scale, the type of corrosion or scale present.

15. (canceled)

16. (canceled)

17. A conduit inspection assembly for capturing images of an interior surface of said conduit, the conduit inspection assembly comprising:
an elongate tubular housing;
a lighting array comprising a plurality of light emitters arranged to illuminate said interior surface; and
a camera having an image sensor configured to detect a plurality of different narrowband wavelength ranges of light.

18. A conduit inspection assembly as claimed in claim 17, in which the camera is a sideview camera and the lighting array comprises a plurality of annular subarrays extending circumferentially around the inspection assembly, or in which the camera is a forward-facing down view camera and the lighting array comprises a plurality of concentric annular subarrays disposed rearwardly of a lens of the camera, each of the light emitters being generally forward-facing.

19. (canceled)

20. A conduit inspection assembly as claimed in claim 18, in which the light emitters in each of the subarrays emit light in a different discrete narrowband wavelength range, or in which the conduit inspection assembly further comprises an optical filtering module arranged to filter light into a plurality of discrete narrowband wavelength ranges prior to entering a lens of the camera.

21. (canceled)

22. (canceled)

23. (canceled)

24. A method according to claim 1, in which the camera is a hyperspectral camera.

25. A method according to claim 1, in which each of the plurality of discrete narrowband wavelength ranges has a full width half maximum value of no more than 30 nm, or in which the plurality of discrete narrowband wavelength ranges comprises two or more from the set of wavelength ranges comprising 500-520 nm, 660-680 nm, 760-770 nm, 830-850 nm and 900-1700 nm.

26. A conduit inspection assembly as claimed in claim 17, in which each of the plurality of discrete narrowband wavelength ranges has a full width half maximum value of no more than 30 nm, or in which the plurality of discrete narrowband wavelength ranges comprises two or more from the set of wavelength ranges comprising 500-520 nm, 660-680 nm, 760-770 nm, 830-850 nm and 900-1700 nm.

27. (canceled)

28. The use of the conduit inspection assembly of claim 17 to image an internal surface of a pipeline conveying a fluid to determine the presence of corrosion or scale.

29. (canceled)

30. A conduit inspection assembly as claimed in claim 17, in which the camera is a hyperspectral camera.
